(19) United States
(12) Patent Application Publication
(10) Pub. No.: US 2022/0048163 A1
(43) Pub. Date: Feb. 17, 2022

(54) VARIABLE BOX SPANNER CAPABLE OF FASTENING AND DISSEMBLING BOLTS OF VARIOUS SIZES BY USING MOVABLE BOLT HEAD PROTRUSION LATCH AND ADJUSTMENT SCREW

(71) Applicant: MIRAETOOL CO., LTD., Hwaseong-si, Gyeonggi-do (KR)

(72) Inventor: Choong Hyun CHOI, Suwon-si, Gyeonggi-do (KR)

(73) Assignee: MIRAETOOL CO., LTD., Hwaseong-si, Gyeonggi-do (KR)

(21) Appl. No.: 17/414,940

(22) PCT Filed: Dec. 20, 2019
(86) PCT No.: PCT/KR2019/018181

§ 371 Date: Jun. 16, 2021

(30) Foreign Application Priority Data
Dec. 21, 2018 (KR) 10-2018-0167520

(51) Int. Cl. B25B 13/12; B25B 23/10; B25B 23/00

(52) U.S. Cl. CPC B25B 13/12; B25B 23/0035; B25B 23/108

(57) ABSTRACT

The present invention provides a spanner box including a main shaft (3) which has a cylindrical shape, a screw thread (3-2) is formed in a central region of an outer side surface, a side surface is cut from the central region, a second spring groove (3-3) is formed in a bottom surface of the bolt head protrusion latch movement groove (3-4), and one end portion of an elastic part (4) is disposed in the second spring groove (3-3), first bolt head protrusion latches (1) each of which having a thickness suitable for being insertable into the main shaft coupling bolt tab (3-5), an irregularity (1-1) is formed in a bottom surface of a lower end portion, a spring groove (1-4) is formed at one side of a bottom surface of an upper end portion, and a movement groove (1-2) is formed at a center of a side surface.

### TECHNICAL FIELD

The present invention relates to a variable box spanner, which allows coupling and decoupling of bolts having various sizes using a movable bolt head protrusion latch which is variably adjustable according to a size of a head of a bolt and an adjustment screw, as a tool configured to tighten the bolt.

### BACKGROUND ART

In order to couple machine parts and the like, bolts and nuts are generally used. When the machine parts and the like need to be coupled, the bolts or nuts should be tightened, and in a case in which the coupling needs to be decoupled for the purpose of repair and the like, the bolts or nuts should be loosened. Generic tools used to tighten or loosen bolts or nuts as described above are spanners. In a box spanner which is one of the spanners, a separate lever is connected to a small cylindrical body (box wrench) in which a hexagonal hole having a predetermined size is formed, a head portion of a bolt or nut to be tightened or loosened is covered with the cylindrical body, and the lever is turned to the right or left to tighten or loosen the corresponding bolt or nut.

Bolts and nuts having various dimensions are used according to the degree of coupling force. In order to tighten or loosen the bolts or nuts having various dimensions, many spanner boxes having different dimensions are needed for the corresponding dimensions of the bolts or nuts. Accordingly, the plurality of spanner boxes having different dimensions are set and accommodated in one toolbox to be sold, and in a workplace using the plurality of spanner boxes, the plurality of spanner boxes are managed as a group.

Since the bolts/nuts that the plurality of spanner boxes can be used on are set, a variable spanner box, which may be applied to bolts and nuts having various sizes, has been developed to solve the inconvenience of a worker replacing a box spanner and using a corresponding spanner box and to improve work efficiency while the worker uses a box spanner.

### TECHNICAL PROBLEM

The present invention is directed to improving an economical use effect and workability by improving a spanner to vary the range of specifications for tightening or loosening a bolt or nut and to reduce the number of spanner tools which are replaced during working.

### TECHNICAL SOLUTION

One aspect of the present invention provides a spanner box including first bolt head protrusion latches (1) each of which is formed in a rod shape having a thickness suitable for being insertable into a main shaft coupling bolt tab (3-5) and in which an end portion of one side of an upper surface is formed to be inclined, an irregularity (1-1) is formed in a bottom surface of a lower end portion in a longitudinal direction, a spring groove (1-4) is formed at one side of a bottom surface of an upper end portion so that a spring is insertable into the spring groove (1-4), and a movement groove (1-2) is formed at a center of a side surface to have a size corresponding to a thickness of a sleeve part of a main shaft (3) so as to be hooked when inserted into the main shaft coupling bolt tab (3-5); an adjustment screw (2) which is formed in a pipe shape and in which a screw part (2-2) corresponding to a screw thread (3-2) of the main shaft (3) is formed on an inner circumference, and a skid prevention knurling treatment is performed on an outer surface extending from the screw part (2-2); the main shaft (3) which has a cylindrical shape and in which a ratchet tetragonal groove (3-1) to which a ratchet is coupled is formed in one end surface, the screw thread (3-2) is formed in a central region of an outer side surface, a side surface is cut from the central region in a circumferential direction to form a bolt head protrusion latch movement groove (3-4) having a [symbol] shape and the main shaft coupling bolt tab (3-5) formed at one side of the bolt head protrusion latch movement groove (3-4), a second spring groove (3-3) is formed in a bottom surface of the bolt head protrusion latch movement groove (3-4) in a shaft axial direction at a position corresponding to the spring groove (1-4) of the first bolt head protrusion latch (1) so that a position of the second spring groove (3-3) is matched with a position of the first spring groove (1-4) when assembled; an elastic part (4) is disposed between the first spring groove (1-4) and the second spring groove (3-3) to apply elasticity to the first bolt head protrusion latch (1); and a reverse-rotation prevention nut (5) which is formed in a disc shape and in which a screw part (5-1) corresponding to the screw thread (3-2) of the main shaft (3) is formed on an inner circumference and a skid prevention knurling treatment is performed on an outer surface, wherein the adjustment screw (2) is rotated to change a position of the inclined portion (2-1) so as to adjust distances between the first bolt head protrusion latches (1).

A second aspect of the present invention provides a spanner box including a second sliding plate (6) which is formed in a pipe shape of which an end surface of one side is closed and in which a rotary shaft groove (6-2) of a main motion conversion shaft is formed to pass through a central region of the closed end surface, second bolt head protrusion latch movement grooves (6-1) are radially formed in linear shapes at angular intervals of 120° about the rotary shaft groove (6-2) to pass therethrough, and a stopper movement groove (6-3) is formed at one side of a side surface; a main motion conversion shaft (7) which includes a disc plate (7-1) having a diameter smaller than an inner diameter of the second sliding plate (6), reverse-rotation prevention teeth (7-3) formed in a region, which is greater than ⅓ of an outer circumferential surface, on the outer circumferential surface of the disc plate (7-1) in a direction perpendicular to the disc plate (7-1), a protruding portion (7-7) formed at a central position of the disc plate (7-1) to be insertable into the rotary shaft groove (6-2), a first rivet tetragonal groove (7-5) formed to pass through the protruding portion (7-7), second bolt head protrusion latch round guide grooves (7-2) formed at angular intervals of 120° about the protruding portion (7-7) in “∩” shapes to pass through the disc plate (7-1), a rachet insertion shaft (7-4) formed to be connected to a bottom surface of the disc plate (7-1), to have a diameter smaller than a diameter of the disc plate (7-1), and to extend in a pipe shape, and a rachet tetragonal groove (7-6) formed to pass through a center of the rachet insertion shaft (7-4) and to be concentric with the protruding portion (7-7); an auxiliary motion conversion plate (8) which is formed in a circular plate shape having a diameter which is the same as a diameter of the second sliding plate and in which a second rivet tetragonal groove (8-2) is formed to be concentric with the rotary shaft groove (6-2), and second bolt head protrusion latch round guide grooves (8-1) each of which one end portion is connected to the second rivet tetragonal groove (8-2) and formed in a “∩” shape about the second rivet tetragonal groove (8-2) to correspond to the second bolt head protrusion latch round guide groove (7-2), second bolt head protrusion latches (9) each of which is formed in a rod shape and in which a second bolt head protrusion latch irregular portion (9-1) is formed on a bottom surface, a second bolt head protrusion latch first circular shaft part (9-3) is formed to extend in a longitudinal direction, and a sliding plate insertion groove (9-2) is formed in a side surface of the second bolt head protrusion latch first circular shaft part (9-3); and a main motion conversion shaft stopper (10) which is inserted into and protrudes from the stopper movement groove (6-3) of the second sliding plate (6) and adjusts rotation of the main motion conversion plate (7).

The second bolt head protrusion latch first circular shaft parts (9-3) may pass through and be inserted into the second bolt head protrusion latch round guide grooves (8-1), the second bolt head protrusion latch movement grooves (6-1), and the second bolt head protrusion latch round guide grooves (7-2) and move along the second bolt head protrusion latch round guide grooves (8-1), the second bolt head protrusion latch movement grooves (6-1), and the second bolt head protrusion latch round guide grooves (7-2) to adjust distances between the second bolt head protrusion latch irregular portions (9-1).

A third aspect of the present invention provides a spanner box including a sliding part (13) which is formed in a pipe shape of which an end surface of one side is closed and in which a circular groove (13-1) and sliding grooves (13-2) disposed at angular intervals of 120° are formed at a central portion of the closed end surface; third bolt head protrusion latches (14) each of which is formed in a rod shape and in which an irregular portion (14-2) is formed on a surface which holds a bolt head, an end portion of one rear side of the irregular portion is cut to form an inclined surface (14-3), a central region of a side surface is cut in a direction perpendicular to a longitudinal direction of the rod shape to form a movement groove (14-1); a pressing shaft (15) which is formed in a cylindrical shape and in which latch insertion grooves (15-1) are radially formed in an end portion of one side at angular intervals of 120° in an axial direction of the pressing shaft (15) so that the third bolt head protrusion latches (14) are insertable into the latch insertion grooves (15-1), inclined surfaces (15-2) corresponding to the inclined surfaces (14-3) of the third bolt head protrusion latches (14) are formed in the latch insertion grooves (15-1), a central shaft of an end portion of the other side extends to form a rivet connection shaft (15-3), and a rivet groove (15-5) is formed to pass through an end portion of the rivet connection shaft; and a main body (16) which is formed in a pipe shape of which one side is closed and in which an inner circumference is formed so that the pressing shaft (15) is rotatably inserted into the main body (16), a lever connection shaft (16-4), in which an insertion hole is formed to pass through a central portion of the closed end portion and the rivet connection shaft (15-3) is insertable into the insertion hole, is formed to protrude, a second rivet groove is formed in the lever connection shaft (16-4) at a position corresponding to the rivet groove (15-5) when the rivet connection shaft (15-3) is inserted, and a circular rod-shaped grip (16-2) passes through and is coupled to the rivet groove (15-5).

In the pressing shaft (15), an outer circumferential surface may be formed to have a two-step outer circumference, end portions of the outer circumference may be formed to be different, the outer circumference may be formed to be enlarged at the end portion of the other side to form a spring jaw (15-4), a pressing shaft return spring (18) may be coupled to a side at which the outer circumference is smaller and inserted between the main body (16) and the pressing shaft, and the spring (18) may be hooked on the spring jaw (15-4) to return the sliding part (13) toward the closed end portion.

The spanner box may further include a pressing shaft lever (17) which is formed as an arc-shaped frame and in which the grip (16) is connected to an end portion of one side.

A pressing shaft coupling pin hole (17-2) may be formed in a central region of an arc of the pressing shaft lever (17), and the pressing shaft lever (17) may be rotatably connected to the rivet connection shaft (15-3) of the pressing shaft (15) through a pin.

### ADVANTAGEOUS EFFECTS

According to the present invention, since box users do not need to manage a plurality of box spanners having different sizes, the time spent on tool management can be reduced, since re-purchasing due to loss is significantly decreased, economic benefits can be achieved, and breakage of a bolt head, which may occur due to use of an inappropriate box spanner, can be prevented. In addition, the waste of many human and material resources required for manufacturing and supplying several tens of types of box spanners can be prevented over the whole industry.

### DESCRIPTION OF DRAWINGS

FIG. 1 is a partially cut view illustrating a spanner box according to a first embodiment of the present invention.

FIG. 2 is a perspective view illustrating a first bolt head protrusion latch of the spanner box illustrated in FIG. 1.

FIG. 3 is a cross-sectional view illustrating an adjustment screw of the spanner box illustrated in FIG. 1.

FIG. 4 is a cross-sectional view illustrating a main shaft of the spanner box illustrated in FIG. 1.

FIG. 5 is a perspective view illustrating a reverse-rotation prevention nut of the spanner box illustrated in FIG. 1.

FIG. 6 shows partially cut views illustrating operations of the spanner box illustrated in FIG. 1.

FIG. 7 is an exploded perspective view illustrating a spanner box according to a second embodiment of the present invention.

FIG. 8 is a perspective view illustrating a second sliding plate of the spanner box illustrated in FIG. 7.

FIG. 9 is a cross-sectional view illustrating a main motion conversion shaft of the spanner box illustrated in FIG. 7.

FIG. 10 is a perspective view illustrating an auxiliary motion conversion plate of the spanner box illustrated in FIG. 7.

FIG. 11 is a view illustrating a second bolt head protrusion latch of the spanner box illustrated in FIG. 7.

FIG. 12 is a view illustrating a main motion conversion shaft stopper of the spanner box illustrated in FIG. 7.

FIG. 13 is a view illustrating a main motion conversion shaft stopper cover of the spanner box illustrated in FIG. 7.

FIG. 14 shows views illustrating operations of the spanner box illustrated in FIG. 7.

FIG. 15 is an exploded perspective view illustrating a spanner box according to a third embodiment of the present invention.

FIG. 16 is a view illustrating a sliding bar of the spanner box illustrated in FIG. 15.

FIG. 17 is a view illustrating a third bolt head protrusion latch of the spanner box illustrated in FIG. 15.

FIG. 18 is a cross-sectional view illustrating a pressing shaft of the third bolt head protrusion latch of the spanner box illustrated in FIG. 15.

FIG. 19 a view illustrating a main body of the spanner box illustrated in FIG. 15.

FIG. 20 is a perspective view illustrating an auxiliary grip of the spanner box illustrated in FIG. 15.

FIG. 21 shows views illustrating operations of the spanner box illustrated in FIG. 15.

### MODES OF THE INVENTION

Advantages and features of the present invention and methods of achieving the same will be clear with reference to the following embodiments which will be described in detail with the accompanying drawings. However, the present invention is not limited to the embodiments to be disclosed below and may be implemented in various different forms, the embodiments are provided in order to fully describe the present invention and fully inform the scope of the present invention to those skilled in the art, and the scope of the present invention is only defined by the appended claims. Like reference numerals refer to like elements throughout the specification.

Hereinafter, specific contents for implementing the present invention will be described in more detail with reference the accompanying drawings.

### First Embodiment

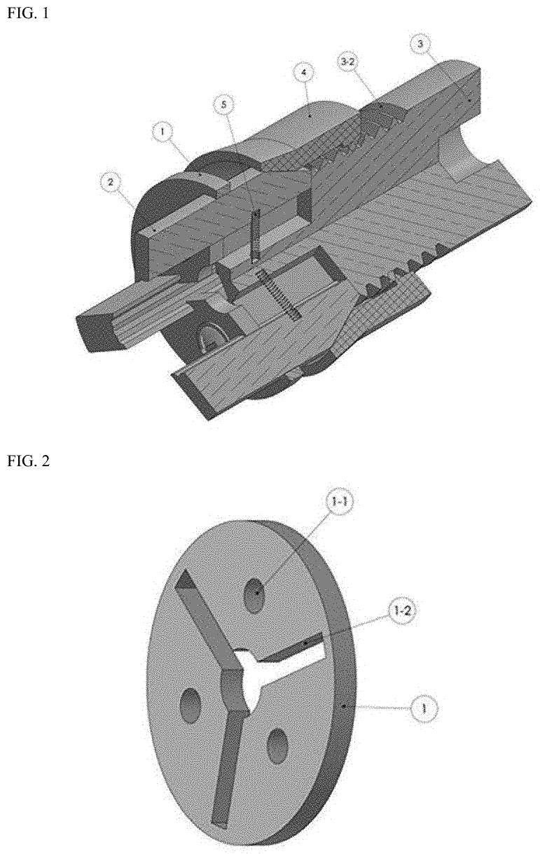

FIGS. 1 to 6 are views illustrating a spanner box according to a first embodiment of the present invention.

As illustrated in FIG. 1, the spanner box according to the first embodiment of the present invention includes a main shaft 3, first bolt head protrusion latches 1, an adjustment screw 2, springs 4, and a reverse-rotation prevention nut 5. Three bolt head protrusion latches 1 are inserted into an upper portion of the main shaft 3 and assembled at angular intervals of 120°, the main shaft 3 is installed in a central portion of the spanner box, the springs 4 are installed between the main shaft 3 and the first bolt head protrusion latches 1, and the adjustment screw 2 and the reverse-rotation prevention nut 5 are coupled to the main shaft 3.

FIG. 2 is a perspective view illustrating the first bolt head protrusion latch 1 illustrated in FIG. 1. The first bolt head protrusion latch 1 is formed in a rod shape to be inserted into a groove 2-2 having a [symbol] shape. An inclined jaw 1-3 formed to be inclined toward an end portion at a side at which the first bolt head protrusion latch 1 meets the main shaft 3 is formed on an upper surface of an upper portion of each of the first bolt head protrusion latches 1. An irregularity 1-1 is formed on a bottom surface of a lower portion in a longitudinal direction, and when a bolt head is gripped to be used, a holding force of the spanner box for the bolt head is increased due to friction of the irregularity. In addition, spring grooves 1-4 into which the springs 4 are inserted are formed in a bottom surface of the upper portion.

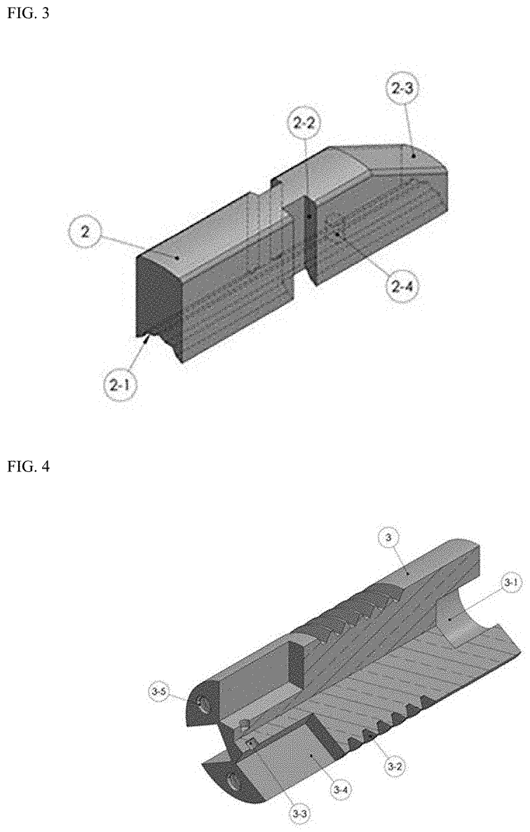

FIG. 3 is a perspective view illustrating the adjustment screw 2. As illustrated in the drawing, the adjustment screw 2 is formed in a pipe shape. The adjustment screw 2 includes a screw part 2-2 formed to have an inner diameter corresponding to a diameter of a screw thread 3-2 to be screw-coupled to the screw thread 3-2 of the main shaft 3 and an inclined portion 2-1 extending from the screw part 2-2. A height corresponding to the bolt head protrusion latch 1 is set according to an inner diameter of the inclined portion 2-1. According to a size of a bolt to be applied, a position of a bottom surface, on which the irregularity 1-1 is formed, of each of the three bolt head protrusion latches 1 is adjusted. A position of the bolt head protrusion latch 1 may be adjusted by adjusting a position of the inclined portion 2-1 of the adjustment screw 2-2.

FIG. 4 is a view illustrating the main shaft 3. In the main shaft 3, a cylindrical shape is formed as a whole, a ratchet tetragonal groove 3-1 coupled to a ratchet is formed in one end surface thereof, and the screw thread 3-2 for coupling with the adjustment screw 4 and the reverse-rotation prevention nut 5, which will be described below, is formed on a central region. In the other end surface thereof, a bolt head protrusion latch movement groove 3-4 and the main shaft coupling bolt tab 3-5 are formed by cutting a side surface in a circumferential direction from a central region. The bolt head protrusion latch is inserted to match with positions of the bolt head protrusion latch movement groove 3-4 and the main shaft coupling bolt tab 3-5. In a bottom surface of the second main shaft coupling bolt tab in a shaft axial direction, second spring grooves 3-3 are formed at positions corresponding to the spring grooves 1-4 of the first bolt head protrusion latch 1, and when assembled, the positions of the second spring grooves 3-3 are matched with positions of the first spring grooves 1-4, and elastic parts such as the springs 4 are disposed between the first spring grooves 1-4 and the second spring grooves 3-3 so that elasticity by which the first bolt head protrusion latches 1 are moved from a bottom surface in a central axis direction of the bolt head protrusion latch movement groove 3-4 of the main shaft 3 toward the side surface is applied.

FIG. 5 is a perspective view illustrating the reverse-rotation prevention nut 5. As illustrated in the drawing, the reverse-rotation prevention nut 5 is formed in a pipe shape. The reverse-rotation prevention nut 5 includes a screw part 5-1 formed to have an inner diameter corresponding to the diameter of screw thread 3-2 to be screw-coupled to the screw thread 3-2 of the main shaft 3 and an outer surface 5-2 formed outside the screw part 5-1. The adjustment screw 4 may be prevented from being loosened by gripping and tightening the outer surface 5-2.

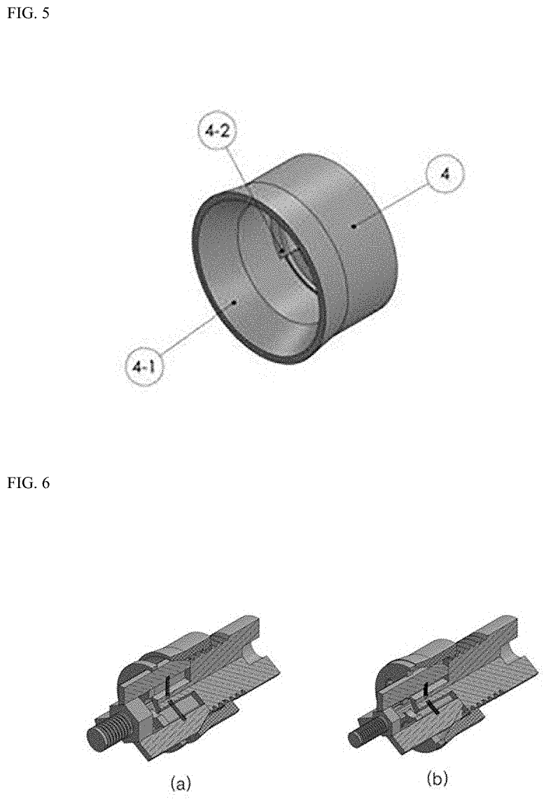

A coupling state of the spanner box according to the first embodiment of the present invention will be described with reference to FIG. 6. The adjustment screw 2, which presses the inclined jaw 1-3 of the first bolt head protrusion latch 1 to move the first bolt head protrusion latch 1 to a center, is installed on the screw part 3-2 of the first main shaft 3. In the first bolt head protrusion latch 1 illustrated in FIG. 2, a groove 1-2 having a size corresponding to a thickness of a sleeve of a central shaft is machined in a side surface of a shaft having an arc-shaped cross-section, the irregularity 1-1 is formed in the bottom surface, and the inclined jaw 1-3 is formed on the other end portion of the upper surface. As illustrated in FIG. 4, the screw thread 3-2 is formed on an outer circumferential portion of the main shaft 3, the second guide groove 1-2 which extends from one end of the screw thread 3-2 and is formed to correspond to the first bolt head protrusion latches 1 to allow the first bolt head protrusion latches 1 to enter at angular intervals of 120° is machined, and the ratchet tetragonal groove 3-1 into which the ratchet may be inserted is formed in the other end portion.

Operations of the spanner box according to the first embodiment of the present invention will be described with reference to FIG. 6. FIG. 6A is a view illustrating a state in which the adjustment screw is moved rearward, and FIG. 6B is a view illustrating a state in which the adjustment screw is moved forward.

FIG. 6A is the view illustrating the state in which the adjustment screw is moved rearward to maximize the intervals between the bolt head protrusion latches so as to tighten or loosen a bolt having a large head, and FIG. 6B is the view illustrating the state in which the intervals of the bolt head protrusion latches are minimally adjusted so as to tighten or loosen a bolt having a small head. Accordingly, in the present invention, any bolt between the maximum interval and the minimum interval of the bolt head protrusion latches can be coupled and decoupled.

### Second Embodiment

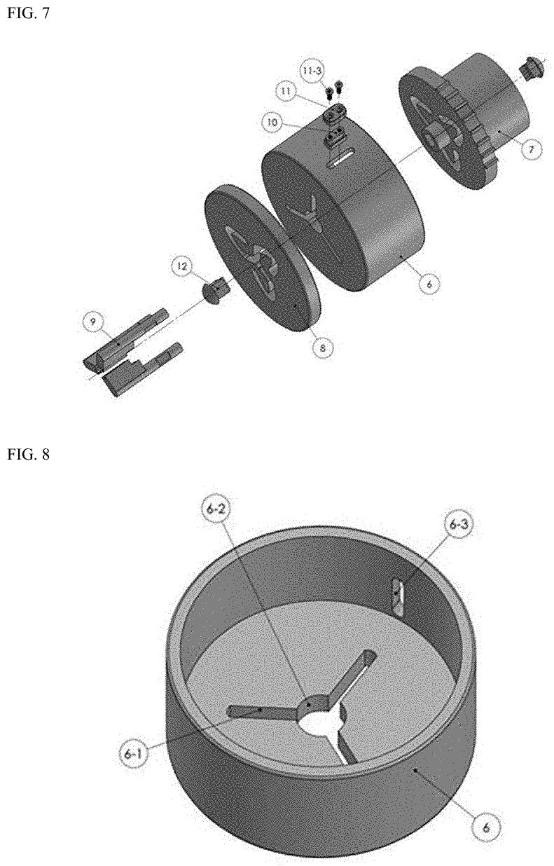

FIGS. 7 to 14 are views illustrating a spanner box according to a second embodiment of the present invention. FIG. 7 is an exploded perspective view illustrating the spanner box according to the second embodiment of the present invention, and as illustrated, the spanner box according to the second embodiment of the present invention includes a second sliding plate 6, a main motion conversion shaft 7, an auxiliary motion conversion plate 8, second bolt head protrusion latches 9, a main motion conversion shaft stopper 10, a stopper cover 11, and a coupling rivet 12.

FIG. 8 is a perspective view illustrating the second sliding plate 6 according to the second embodiment of the present invention. As illustrated in the drawing, in the second sliding plate 6, a pipe shape of which an end surface of one side is closed is formed, a rotary shaft groove 6-2 for the main motion conversion shaft, which will be described below, is formed to pass a central region of the closed end surface, second bolt head protrusion latch movement grooves 6-1 are formed at angular intervals of 120° around the rotary shaft groove 6-2 and each have a linear shape to pass therethrough, and a stopper movement groove 6-3 is formed at one side of a side surface.

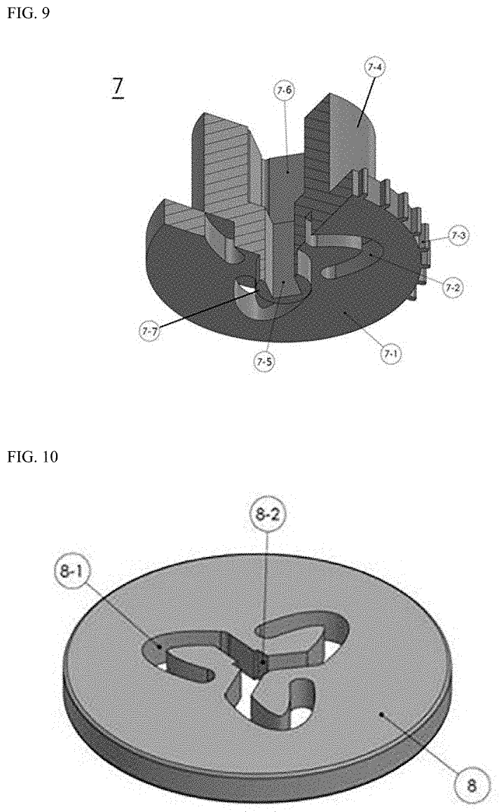

FIG. 9 is a cut-away perspective view illustrating the main motion conversion shaft 7 according to the second embodiment. In the main motion conversion shaft 7, a disc plate 7-1 having a diameter smaller than an inner diameter of the second sliding plate 6, reverse-rotation prevention teeth 7-3 formed in a region, which is greater than ⅓ of an outer circumferential surface, on the outer circumferential surface of the disc plate 7-1 in a direction perpendicular to the disc plate 7-1, and a protruding portion 7-7 to be inserted into the rotary shaft groove 6-2 at a central position of the disc plate 7-1 are formed, a first rivet tetragonal groove 7-5 is formed to pass through the protruding portion 7-7, and second bolt head protrusion latch round guide grooves 7-2 are formed in a “∩” shape to pass through the disc plate 7-1 at angular intervals of 120° around the protruding portion 7-7. A rachet insertion shaft 7-4 is formed to be connected to a bottom surface of the disc plate 7-1, to have a diameter smaller than the diameter of the disc plate 7-1, and to extend in a pipe shape, and a rachet tetragonal groove 7-6 is formed to pass through the rachet insertion shaft 7-4 and to be concentric with the protruding portion 7-7. A size of the sum of a protruding size of the reverse-rotation prevention tooth 7-3 and the diameter of the disc plate 7-1 is set to a corresponding size to be rotatably inserted into an inner circumference of the second sliding plate 6.

FIG. 10 is a perspective view illustrating the auxiliary motion conversion plate 8. The auxiliary motion conversion plate 8 is formed in a circular plate shape. The auxiliary motion conversion plate 8 is formed to have a diameter which is the same as a diameter of the second sliding plate, a second rivet tetragonal groove 8-2 is formed to be concentric with the rotary shaft groove 6-2 and formed in a shape which concentrically corresponds to the first rivet tetragonal groove 7-5, and the coupling rivet 12 is coupled to the second rivet tetragonal groove 8-2. Second bolt head protrusion latch round guide grooves 8-1, each of which one end portion is connected to the second rivet tetragonal groove 8-2 and which has a “∩” shape, are formed around the second rivet tetragonal groove 8-2 in correspondence with the second bolt head protrusion latch round guide grooves 7-2.

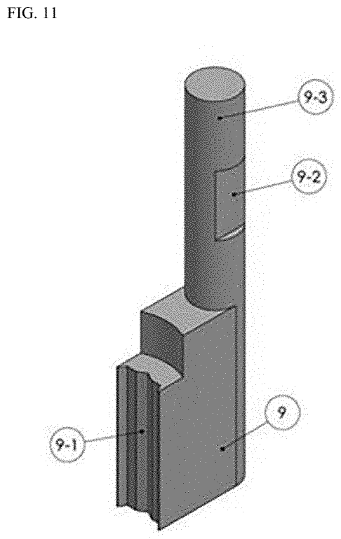

FIG. 11 is a perspective view illustrating the second bolt head protrusion latch 9. As illustrated in the drawing, the second bolt head protrusion latch 9 is formed in a rod shape. A second bolt head protrusion latch irregular portion 9-1 is formed in a surface, by which a bolt head is to be held, of each of the second bolt head protrusion latches 9, a holding force of the spanner box for a bolt head is increased due to an irregularity when gripping the bolt head. A second bolt head protrusion latch first circular shaft part 9-3 is formed to extend in a longitudinal direction, and a sliding plate insertion groove 9-2 is formed in a side surface of the shaft part 9-3. The second bolt head protrusion latch first circular shaft part 9-3 passes through and is inserted into the second bolt head protrusion latch round guide groove 8-1, the second bolt head protrusion latch movement groove 6-1 and the second bolt head protrusion latch round guide groove 7-2, moves along the guide groove 8-1, the movement groove 6-1, and the guide groove 7-2, and adjusts a distance between the second bolt head protrusion latch irregular portions 9-1.

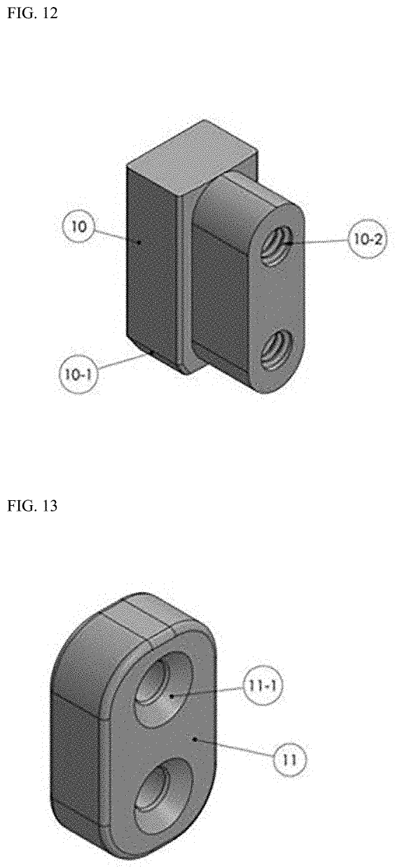

FIG. 12 is a perspective view illustrating the main motion conversion shaft stopper 10. The main motion conversion shaft stopper 10 is inserted into and protrudes from the stopper movement groove 6-3 of the second sliding plate 6 and adjusts rotation of the main motion conversion plate 7. A stopper movement groove main motion conversion shaft stopper inclined portion 10-1 is formed, and main motion conversion shaft stopper screw tabs 10-2 are formed on a side surface.

FIG. 13 is a perspective view illustrating the stopper cover 11. Main motion conversion shaft stopper cover screw grooves are formed in a side surface to have shapes and sizes corresponding to the stopper screw tabs 10-2.

The spanner box formed as described above according to the second embodiment has a structure in which the second bolt head protrusion latches 9 are formed at the angular intervals of 120° on the second sliding plate 6 and the main motion conversion shaft 7 and the auxiliary motion conversion plate 8, which control the motion of the second bolt head protrusion latches 9, are coupled with the second sliding plate 6 interposed therebetween by the tetragonal rivet, and when a rotation force is applied to the main motion conversion shaft, the second bolt head protrusion latches 9 move in a circumferential direction or in a direction toward an original point due to the circular shaft part guide grooves 7-2 of the main motion conversion shaft, and distances between the second bolt head protrusion latches 9 may be adjusted to tighten a head of a bolt having an arbitrary size, and when the rotation force is continued, pressure may be applied to the bolt head in the circumferential direction and a turning force may be applied thereto at the same time to couple or decouple the bolt in a rotation direction, wherein in the case of reverse rotation, the bolt may be coupled or decoupled in the same manner, and in a case in which a ratchet is installed in the ratchet tetragonal groove 7-4 attached to the main motion conversion shaft, when the ratchet is reversely rotated, the reverse rotation is prevented due to the stopper cover 11 for preventing rotation of the main motion conversion shaft being installed on the side surface of the sliding plate.

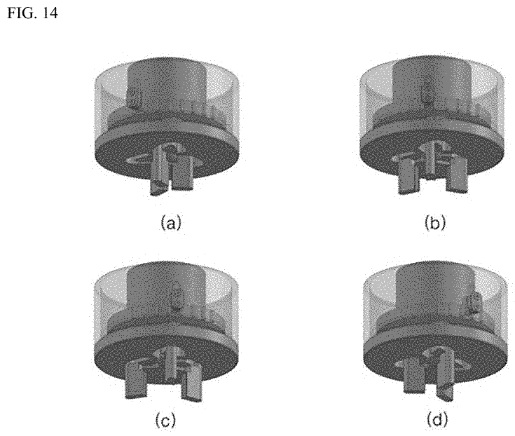

FIG. 14A is a view illustrating an operation when a small bolt is coupled, FIG. 14B is a view illustrating an operation when a large bolt is coupled, FIG. 14C is a view illustrating an operation when the large bolt is decoupled, and FIG. 14D is a view illustrating an operation when the small bolt is decoupled.

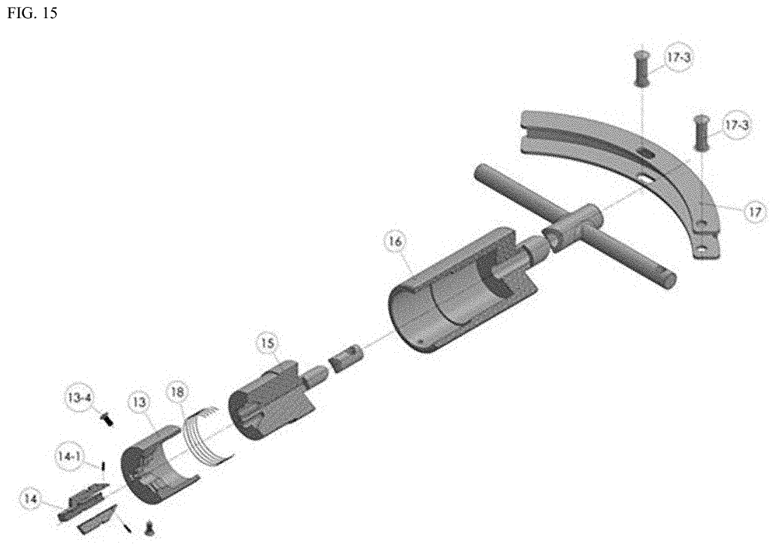

FIGS. 15 to 21 are exploded perspective views illustrating a spanner box according to a third embodiment of the present invention. As illustrated in the drawings, the spanner box according to the third embodiment of the present invention includes a sliding part 13, third bolt head protrusion latches 14, a third bolt head protrusion latch pressing shaft 15, a main body 16, a pressing shaft lever 17, and a pressing shaft return spring 18.

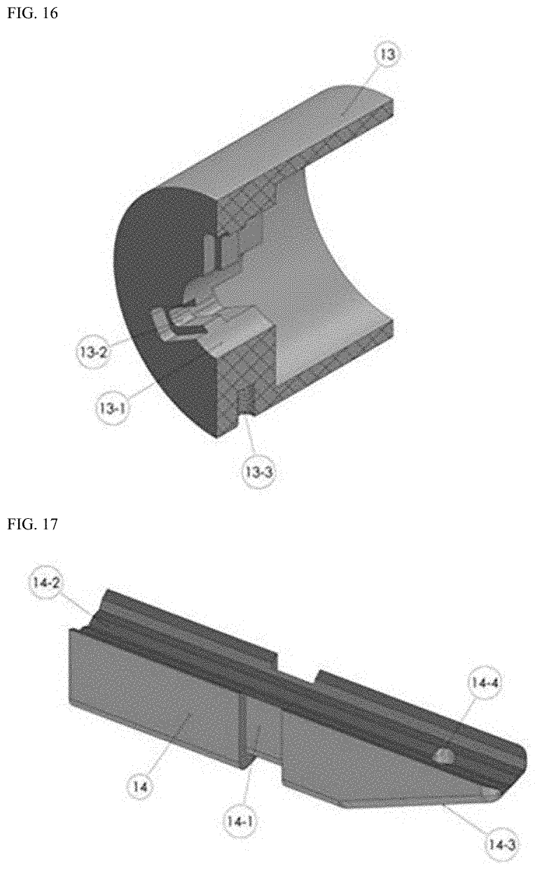

FIG. 16 is a view illustrating the sliding part 13 of the spanner box illustrated in FIG. 15. As illustrated in the drawing, the sliding part 13 is formed in a pipe shape of which an end surface of one side is closed, a circular groove 13-1 and sliding grooves 13-2 disposed at angular intervals of 120° are formed to pass through a central portion of the closed end surface.

FIG. 17 is a view illustrating the third bolt head protrusion latch 14 of the spanner box illustrated in FIG. 15. Three third bolt head protrusion latches 14 are coupled. Each of the third bolt head protrusion latches 14 is formed in a rod shape, an irregular portion 14-2 is formed in a surface which holds a bolt head, an end portion of one rear side of the irregular portion is cut to form an inclined surface 14-3, and a central region of a side surface is cut in a direction perpendicular to a longitudinal direction of the rod shape to form a movement groove 14-1.

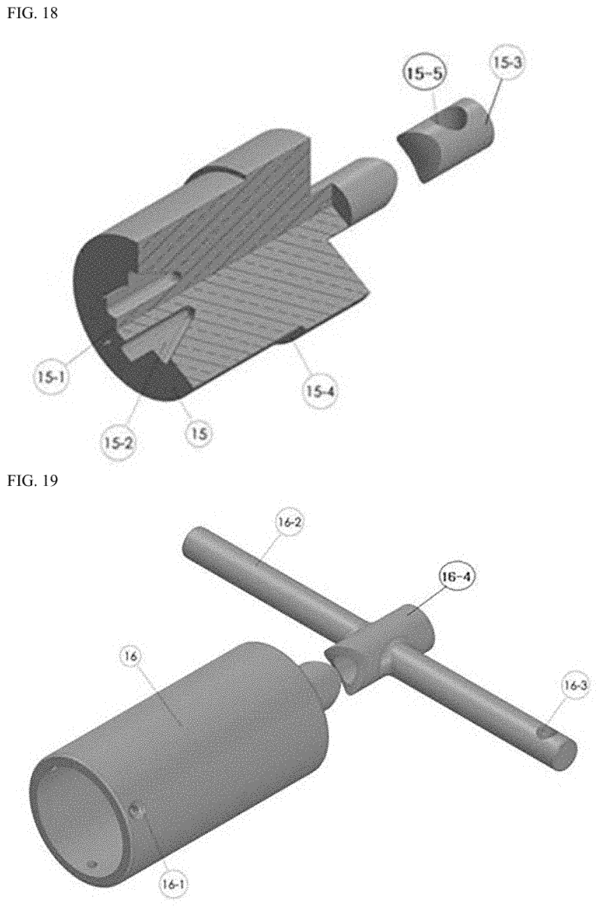

FIG. 18 is a cross-sectional view illustrating the pressing shaft 15 for the third bolt head protrusion latch of the spanner box illustrated in FIG. 15. As illustrated in the drawing, in the pressing shaft 15, a cylindrical shape is formed, latch insertion grooves 15-1 may be radially formed in an end portion of one side at angular intervals of 120° in an axial direction of the pressing shaft 15 so that the third bolt head protrusion latches 14 are inserted into the latch insertion grooves 15-1, and an inclined surface 15-2 corresponding to the inclined surface 14-3 of the third bolt head protrusion latch 14 may be formed in each of the latch insertion grooves 15-1. An outer circumferential surface of the pressing shaft 15 is formed to have a two-step outer circumference, and the outer circumference is formed to be enlarged to form a spring jaw 15-4 at an end portion of the other side. The pressing shaft return spring 18 is coupled at a side at which the outer circumference is smaller and inserted into the main body 16 which will be described below. The spring 18 is hooked on the spring jaw 15-4 to apply an elastic force toward the closed end portion so as to return the sliding part 13. A central shaft of an end portion of the other side of the pressing shaft 15 extends to form a rivet connection shaft 15-3, and a rivet groove 15-5 is formed to pass through an end portion of the rivet connection shaft.

FIG. 19 is a view illustrating the main body 16 of the spanner box illustrated in FIG. 15. As illustrated in the drawing, the main body 16 is formed in a pipe shape of which one side is closed and an inner circumference is formed so that the pressing shaft 15 is rotatably inserted into the main body 16. A lever connection shaft 16-4, in which an insertion hole is formed to pass through a center of the closed end portion and the rivet connection shaft 15-3 is inserted into the insertion hole, is formed to protrude. A second rivet groove is formed in the lever connection shaft 16-4 at a position corresponding to the rivet groove 15-5 when the rivet connection shaft 15-3 is inserted thereinto, and a grip 16-2 having a circular rod shape passes through the rivet groove 15-5 and is coupled to the lever connection shaft 16-4. A lever coupling pin connecting groove 16-3 is formed to pass through an end portion of the grip 16-2.

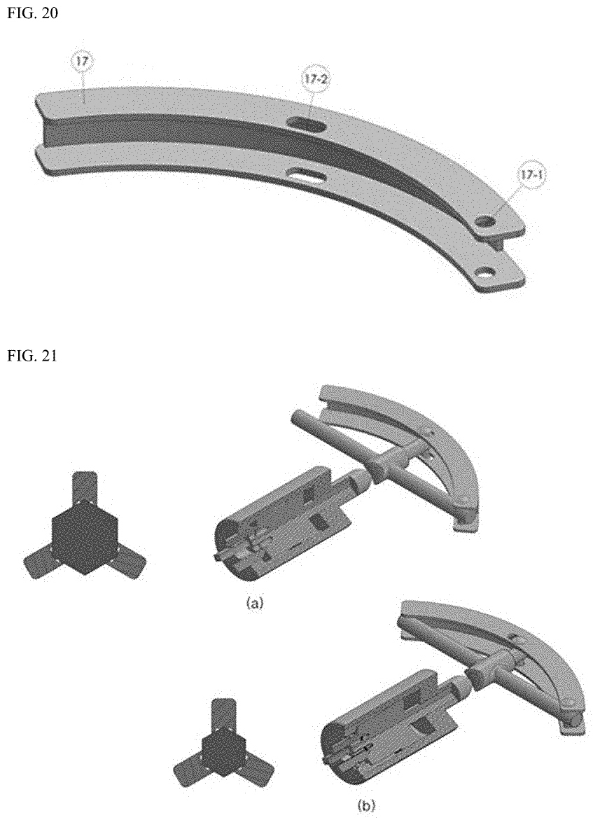

FIG. 20 is a perspective view illustrating the pressing shaft lever 17 of the spanner box illustrated in FIG. 15. As illustrated in the drawing, the pressing shaft lever 17 is formed as an arc-shaped frame, and a grip coupling pin hole 17-1 for coupling of the coupling pin connecting groove 16-3 of the grip 16-2 is formed in an end portion of one side thereof, the grip coupling pin hole 17-1 is matched with the coupling pin connecting groove 16-3, and a coupling pin is inserted thereinto so that the pressing shaft lever 17 and the grip 16 are rotatably coupled. A pressing shaft coupling pin hole 17-2 is formed in a central region of an arc and rotatably connected to the rivet connection shaft 15-3 of the pressing shaft 15 through a pin.

FIGS. 21A and 21B are views illustrating operation states of the spanner box according to the third embodiment of the present invention. As illustrated in the drawings, the third embodiment of the present invention has a structure in which the third bolt head protrusion latches 14 are installed in the sliding part 13 in which the circular groove 13-1 and the sliding grooves disposed at angular intervals of 120° are machined in the central portion, the inclined surface 15-2 into which the inclined portion 14-3 of the third bolt head protrusion latch 14 is insertable is machined in one side surface, and the pressing shaft 15 connected to the pressing shaft lever 17 is installed on the other side surface, and when a distance between the pressing shaft lever 17 and the grip 16-2 is changed, the pressing shaft 15 may press the inclined surfaces 14-3 of the third bolt head protrusion latches to change distances between the third bolt head protrusion latches 14 so as to tighten an arbitrary bolt head, and in the state in which the bolt head is tightened, the grip 16-2 and the pressing shaft lever 17 are rotated to tighten or loosen a bolt, and an auxiliary grip is restored to an original state by the spring 18.

FIG. 21A is a view illustrating a coupling or decoupling operation of a bolt having a large diameter, and FIG. 21B is a view illustrating a coupling or decoupling operation of a bolt having a small diameter.

A feature for implementing a variable box is that a structure is implemented in which bolt head protrusion latches are gathered toward a central point of a bolt or moved away in a circumferential direction to adjust distances between the bolt head protrusion latches according to a size of the bolt head and has a holding force enough to withstand a torque applied when the bolt is coupled or decoupled. To this end, in the present invention, the bolt head protrusion latches are installed in the grooves of the sliding plate so that the bolt head protrusion latches are only allowed to linearly move in a direction toward an original point and in the circumferential direction, and the linear motion is restricted by the adjustment screw having an inclined wing and the conversion plate which converts rotational motion to linear motion, and thus the variable box having the holding strong force can be implemented. The description of the symbols of the present invention shown in FIGS. 1 to 21 are as follows.

1: FIRST BOLT HEAD PROTRUSION LATCH

1-1: IRREGULAR PORTION OF FIRST BOLT HEAD PROTRUSION LATCH

1-2: MOVEMENT GROOVE OF FIRST BOLT HEAD PROTRUSION LATCH

1-3: INCLINED JAW OF FIRST BOLT HEAD PROTRUSION LATCH

1-4: FIRST BOLT HEAD PROTRUSION LATCH SPRING GROOVE

2: ADJUSTMENT SCREW

2-1: ADJUSTMENT SCREW INCLINED PORTION

2-2: ADJUSTMENT SCREW PART

3: MAIN SHAFT

3-1: MAIN SHAFT RATCHET TETRAGONAL GROOVE

3-2: MAIN SHAFT SCREW PART

3-3: MAIN SHAFT SPRING GROOVE

3-4: BOLT HEAD PROTRUSION LATCH MOVEMENT GROOVE

3-5: MAIN SHAFT COUPLING BOLT TAB

4: SPRING

5: REVERSE-ROTATION PREVENTION NUT

5-1: REVERSE-ROTATION PREVENTION NUT SCREW PART SLIDING PLATE B

6-1: SECOND BOLT HEAD PROTRUSION LATCH MOVEMENT GROOVE

6-2: MAIN MOTION CONVERSION SHAFT ROTARY SHAFT GROOVE

6-3: MAIN MOTION CONVERSION SHAFT STOPPER MOVEMENT GROOVE

7: MAIN MOTION CONVERSION PLATE

7-1: FIRST RIVET TETRAGONAL GROOVE

7-2: SECOND BOLT HEAD PROTRUSION LATCH CIRCULAR SHAFT PART GUIDE GROOVE

7-3: REVERSE-ROTATION PREVENTION TEETH

7-4: RATCHET TETRAGONAL GROOVE

8: AUXILIARY MOTION CONVERSION PLATE

8-1: SECOND BOLT HEAD PROTRUSION LATCH CIRCULAR SHAFT PART GUIDE GROOVE

8-2: SECOND RIVET TETRAGONAL GROOVE

9: SECOND BOLT HEAD PROTRUSION LATCH

9-1: SECOND BOLT HEAD PROTRUSION LATCH IRREGULAR PORTION

9-2: SLIDING PLATE INSERTION PART

9-3: SECOND BOLT HEAD PROTRUSION LATCH FIRST CIRCULAR SHAFT PART

10: MAIN MOTION CONVERSION SHAFT STOPPER

10-1: MAIN MOTION CONVERSION SHAFT STOPPER INCLINED PORTION

10-2: MAIN MOTION CONVERSION SHAFT STOPPER SCREW TAB

11: MAIN MOTION CONVERSION SHAFT STOPPER COVER

11-1: MAIN MOTION CONVERSION SHAFT STOPPER COVER SCREW GROOVE

12: COUPLING RIVET

13: SLIDING BAR

13-1: SLIDING BAR CIRCULAR GROOVE

13-2: SLIDING BAR SLIDING GROOVE

13-3: SLIDING BAR SCREW TAB

14: THIRD BOLT HEAD PROTRUSION LATCH

14-1: THIRD BOLT HEAD PROTRUSION LATCH MOVEMENT GROOVE

14-2: THIRD BOLT HEAD PROTRUSION LATCH IRREGULAR PORTION

14-3: THIRD BOLT HEAD PROTRUSION LATCH INCLINED PORTION

14-4: THIRD BOLT HEAD PROTRUSION LATCH SPRING GROOVE

15: PRESSING SHAFT OF THIRD BOLT HEAD PROTRUSION LATCH

15-1: THIRD BOLT HEAD PROTRUSION LATCH INSERTION GROOVE

15-2: THIRD BOLT HEAD PROTRUSION LATCH INCLINED SURFACE

15-3: THIRD BOLT HEAD PROTRUSION LATCH RIVET CONNECTION SHAFT

15-4: BOLT HEAD PROTRUSION LATCH SPRING JAW

15-5: THIRD BOLT HEAD PROTRUSION LATCH RIVET GROOVE

16: MAIN BODY

16-1: COUNTERSUNK GROOVE

16-2: MAIN BODY GRIP

16-3: PRESSING SHAFT LEVER COUPLING PIN GROOVE

17: PRESSING SHAFT LEVER

17-1: GRIP COUPLING PIN HOLE

17-2: PRESSING SHAFT COUPLING PIN HOLE

18: PRESSING SHAFT RETURN SPRING

1. A spanner box comprising:
a main shaft (3) which has a cylindrical shape and in which a ratchet tetragonal groove (3-1) to which a ratchet is coupled is formed in one end surface, a screw thread (3-2) is formed in a central region of an outer side surface, a side surface is cut from the central region in a circumferential direction to form a bolt head protrusion latch movement groove (3-4) having a [symbol] shape and a main shaft coupling bolt tab (3-5) formed at one side of the bolt head protrusion latch movement groove (3-4), a second spring groove (3-3) is formed in a bottom surface of the bolt head protrusion latch movement groove (3-4) in a shaft axial direction, and one end portion of an elastic part (4) is disposed in the second spring groove (3-3);
first bolt head protrusion latches (1) each of which is formed in a rod shape having a thickness suitable for being insertable into the main shaft coupling bolt tab (3-5) and in which an end portion of one side of an upper surface is formed to be inclined, an irregularity (1-1) is formed in a bottom surface of a lower end portion in a longitudinal direction, a spring groove (1-4) is formed at one side of a bottom surface of an upper end portion so that the other end of the elastic part is insertable into the spring groove (1-4), and a movement groove (1-2) is formed at a center of a side surface to have a size corresponding to a thickness of a sleeve part of the main shaft (3) so as to be hooked when inserted into the main shaft coupling bolt tab (3-5);
an adjustment screw (2) which is formed in a pipe shape and in which a screw part (2-2) corresponding to the screw thread (3-2) of the main shaft (3) is formed on an inner circumference and a skid prevention knurling treatment is performed on an outer surface extending from the screw part (2-2); and
a reverse-rotation prevention nut (5) which is formed in a disc shape and in which a screw part (5-1) corresponding to the screw thread (3-2) of the main shaft (3) is formed on an inner circumference and a skid prevention knurling treatment is performed on an outer surface,
wherein the adjustment screw (2) is rotated to change a position of the inclined portion (2-1) so as to adjust distances between the first bolt head protrusion latches (1).

2. A spanner box comprising:
a second sliding plate (6) which is formed in a pipe shape of which an end surface of one side is closed and in which a rotary shaft groove (6-2) of a main motion conversion shaft is formed to pass through a central region of the closed end surface, second bolt head protrusion latch movement grooves (6-1) are radially formed in linear shapes at angular intervals of 120° about the rotary shaft groove (6-2) to pass therethrough, and a stopper movement groove (6-3) is formed at one side of a side surface;
a main motion conversion shaft (7) which includes a disc plate (7-1) having a diameter smaller than an inner diameter of the second sliding plate (6), reverse-rotation prevention teeth (7-3) formed in a region, which is greater than 1/3 of an outer circumferential surface, on the outer circumferential surface of the disc plate (7-1) in a direction perpendicular to the disc plate (7-1), a protruding portion (7-7) formed at a central position of the disc plate (7-1) to be insertable into the rotary shaft groove (6-2), a first rivet tetragonal groove (7-5) formed to pass through the protruding portion (7-7), second bolt head protrusion latch round guide grooves (7-2) formed at angular intervals of 120° about the protruding portion (7-7) in “∩” shapes to pass through the disc plate (7-1), a rachet insertion shaft (7-4) formed to be connected to a bottom surface of the disc plate (7-1), to have a diameter smaller than a diameter of the disc plate (7-1), and to extend in a pipe shape, and a rachet tetragonal groove (7-6) formed to pass through a center of the rachet insertion shaft (7-4) and to be concentric with the protruding portion (7-7);
an auxiliary motion conversion plate (8) which is formed in a circular plate shape having a diameter which is the same as a diameter of the second sliding plate and in which a second rivet tetragonal groove (8-2) is formed to be concentric with the rotary shaft groove (6-2), and second bolt head protrusion latch round guide grooves (8-1) each of which one end portion is connected to the second rivet tetragonal groove (8-2) and formed in a “∩” shape about the second rivet tetragonal groove (8-2) to correspond to the second bolt head protrusion latch round guide groove (7-2);
second bolt head protrusion latches (9) each of which is formed in a rod shape and in which a second bolt head protrusion latch irregular portion (9-1) is formed on a bottom surface, second bolt head protrusion latch first circular shaft parts (9-3) are formed to extend in a longitudinal direction, and a sliding plate insertion groove (9-2) is formed in a side surface of the second bolt head protrusion latch first circular shaft parts (9-3); and
a main motion conversion shaft stopper (10) which is inserted into and protrudes from the stopper movement groove (6-3) of the second sliding plate (6) and adjusts rotation of the main motion conversion plate (7).

3. The spanner box of claim 2, wherein the second bolt head protrusion latch first circular shaft parts (9-3) pass through and are inserted into the second bolt head protrusion latch round guide grooves (8-1), the second bolt head protrusion latch movement grooves (6-1), and the second bolt head protrusion latch round guide grooves (7-2) and move along the second bolt head protrusion latch round guide grooves (8-1), the second bolt head protrusion latch movement grooves (6-1), and the second bolt head protrusion latch round guide grooves (7-2) to adjust distances between the second bolt head protrusion latch irregular portions (9-1).

4. A spanner box comprising:
a sliding part (13) which is formed in a pipe shape of which an end surface of one side is closed and in which a circular groove (13-1) and sliding grooves (13-2) disposed at angular intervals of 120° are formed at a central portion of the closed end surface;
third bolt head protrusion latches (14) each of which is formed in a rod shape and in which an irregular portion (14-2) is formed on a surface which holds a bolt head, an end portion of one rear side of the irregular portion is cut to form an inclined surface (14-3), a central region of a side surface is cut in a direction perpendicular to a longitudinal direction of the rod shape to form a movement groove (14-1);
a pressing shaft (15) which is formed in a cylindrical shape and in which latch insertion grooves (15-1) are radially formed in an end portion of one side at angular intervals of 120° in an axial direction of the pressing shaft (15) so that the third bolt head protrusion latches (14) are insertable into the latch insertion grooves (15-1), inclined surfaces (15-2) corresponding to the inclined surfaces (14-3) of the third bolt head protrusion latches (14) are formed in the latch insertion grooves (15-1), a central shaft of an end portion of the other side extends to form a rivet connection shaft (15-3), and a rivet groove (15-5) is formed to pass through an end portion of the rivet connection shaft; and
a main body (16) which is formed in a pipe shape of which one side is closed and in which an inner circumference is formed so that the pressing shaft (15) is rotatably inserted into the main body (16), a lever connection shaft (16-4), in which an insertion hole is formed to pass through a central portion of the closed end portion and the rivet connection shaft (15-3) is insertable into the insertion hole, is formed to protrude, a second rivet groove is formed in the lever connection shaft (16-4) at a position corresponding to the rivet groove (15-5) when the rivet connection shaft (15-3) is inserted, and a circular rod-shaped grip (16-2) passes through and is coupled to the rivet groove (15-5).

5. The spanner box of claim 4, wherein, in the pressing shaft (15):
an outer circumferential surface is formed to have a two-step outer circumference;
end portions of the outer circumference are formed to be different;
the outer circumference is formed to be enlarged at the end portion of the other side to form a spring jaw (15-4);
a pressing shaft return spring (18) is coupled to a side at which the outer circumference is smaller and inserted between the main body (16) and the pressing shaft; and
the spring (18) is hooked on the spring jaw (15-4) to return the sliding part (13) toward the closed end portion.

6. The spanner box of claim 4, further comprising a pressing shaft lever (17) which is formed as an arc-shaped frame and in which the grip (16) is connected to an end portion of one side.

7. The spanner box of claim 6, wherein:
a pressing shaft coupling pin hole (17-2) is formed in a central region of an arc of the pressing shaft lever (17); and
the pressing shaft lever (17) is rotatably connected to the rivet connection shaft (15-3) of the pressing shaft (15) through a pin.
